(19) United States
(12) Patent Application Publication
(10) Pub. No.: US 2021/0082609 A1
(43) Pub. Date: Mar. 18, 2021

(54) COMMON-MODE/DIFFERENTIAL-MODE THROTTLE FOR AN ELECTRICALLY DRIVEABLE MOTOR VEHICLE

(71) Applicant: Robert Bosch GmbH, Stuttgart (DE)

(72) Inventor: Emiliano Gudino Carrizales, Ludwigsburg (DE)

(21) Appl. No.: 16/772,370

(22) PCT Filed: Nov. 23, 2018
(86) PCT No.: PCT/EP2018/082384

§ 371 Date: Jun. 12, 2020

(30) Foreign Application Priority Data
Dec. 13, 2017 (DE) 10 2017 222 664.1

(51) Int. Cl. H01F 3/12; H02M 1/12; H02M 7/00; H02M 7/5387

(52) U.S. Cl. CPC H01F 3/12; H02M 1/126; H02M 2001/123; H02M 7/5387; H02M 7/003

(57) ABSTRACT

The invention relates to a common-mode/differential-mode throttle (1) for an electrically driveable motor vehicle, with at least a core (4) having two limbs (6, 8) oriented so as to be parallel and spaced from one another, with a common-mode induction coil (L1) and with a differential-mode induction coil (L2), wherein the two induction coils (L1, L2) are each wound around one of the two limbs (6, 8). It is provided for the distance between mutually facing winding sections of the two induction coils (L1, L2) to correspond to the distance between the winding sections at least one of the induction coils (L1, L2) on either side of the respective limb (6, 8).

### BACKGROUND OF THE INVENTION

The invention relates to a common-mode/differential-mode choke for an electrically operable motor vehicle, with a core having at least two limbs aligned parallel and at a distance from one another, with a common-mode induction coil and with a differential-mode induction coil, wherein the two induction coils are each wound around one of the two limbs.

The invention furthermore relates to a transformer with a circuit arrangement which is arranged between a high-voltage side and a low-voltage side of the transformer, wherein a common-mode/differential-mode choke is arranged or connected on at least one of the sides of the transformer.

Common-mode/differential mode chokes of the type mentioned at the outset are already known from the prior art. For example, patent specification EP 2 814 151 A2 discloses an inverter which has an integrated common-mode/differential-mode choke, which has a common-mode induction coil and a differential-mode induction coil. In this case, the two induction coils are wound on a common choke core.

In motor vehicles which are electrically driveable, i.e. in particular electric or hybrid vehicles, energy is transferred from a high-voltage power supply or from a high-voltage battery to a low-voltage power supply, which conventionally has a maximum voltage of 12 volts. This is frequently realized by a single-phase DC voltage converter. In this case, a single-phase transformer transforms the primary voltage (high voltage) to the secondary side (low voltage) and ensures the necessary galvanic separation between the two voltage supply systems to ensure operator safety, amongst other things. The secondary-side AC voltage is then rectified by means of rectifier diodes or by means of a synchronous rectifier. To reduce the ripple of the output voltage, it is moreover known to use a smoothing choke and a smoothing capacitor.

Since the transformer only transfers AC voltage, the high-voltage DC voltage firstly has to be converted into an AC voltage or into a time-variable voltage. This task is conventionally undertaken by high-voltage switches, in particular semiconductor switches. These are actuated in such a way that, during the conducting phase, the entire input voltage is applied to the primary winding of the transformer and induces a secondary voltage. After the conducting phase, the switches are switched off and the voltage at the primary winding is 0 volts. After a dead time, two further switches are actuated in such a way that the entire input voltage is now applied to the primary inductor, but with the reverse polarity. The transformer is therefore operated with an AC voltage. The transformer can also be operated with a pulsed DC voltage. In this case, it must be ensured that it is demagnetized and that saturation of the magnetic material does not occur. To achieve high efficiency, the switches are brought very quickly from the blocked to the conductive state, and vice versa. As a result of the quick switching, the switching losses of the switches are minimized, the speed of the voltage and current change increased. In combination with parasitic, electric components of the printed circuit board, of the components and of the mechanical structure, this quicker voltage and current change involves greater performance interference and electromagnetic interference emissions. The maximum value of the performance interference which is fed into the high-voltage power supply and the low-voltage power supply by the DC voltage converter are standardized and must not be exceeded. By using suitable filters for electromagnetic compatibility (EMF filters), this interference can be reduced to the extent that the device meets all normative requirements. The line-conducted interference is divided into common-mode and differential-mode interference. A common-mode inductor (CMC) or common-mode induction coil reduces the common-mode interference and a differential-mode inductor (DMC) or differential-mode induction coil reduces the differential-mode interference. The EMF directional filters normally require both inductor types, since both interference types occur together. In practice, both inductors are frequently used as two different, physically separate components. However, it is already known from the above-mentioned document to combine the two inductors in one component.

### SUMMARY OF THE INVENTION

The common-mode/directional-mode choke according to the invention has the advantage that the inductances are precisely adjustable, wherein the induction coils are arranged on the same choke core and act without impairing the electrical or magnetic properties of the common-mode induction coil and the differential-mode induction coil. By integrating both induction coils, the installation space is reduced and the choke and, in particular, the transformer having the choke are therefore designed in a compact manner. Moreover, the production costs are lowered and the manufacturing steps reduced. By precisely adapting the two inductances, the EMC properties of the choke and therefore the circuit having the choke are moreover improved. According to the invention, it is provided that the distance between the mutually facing winding portions of the two induction coils corresponds to the mutual distance between the winding portions of at least one of the induction coils on both sides of the respective limb. The choke according to the invention therefore has a defined mutual distance between the two coils at their mutually facing winding portions. In this case, this distance corresponds to the distance between the winding portions of the same induction coil which face away from one another on both sides of the associated limb and therefore the internal diameter of the respective induction coil. As a result of the advantageous selection of the distance, it is possible to adjust the inductances of both induction coils particularly precisely and to thereby ensure optimized operation of the common-mode/differential-mode choke or the circuit having the choke.

According to a preferred embodiment of the invention, it is provided that the core has a center limb, which is arranged between the two limbs already mentioned. The three limbs preferably lie beside one another in a plane, wherein the third limb is also aligned/arranged in particular at a parallel distance from the two other limbs. The third limb therefore projects between the two induction coils, at least in certain portions. This improves the magnetic field guidance and therefore the effect of the choke.

The three limbs preferably have the same width or the same cross-section. This results in a particularly advantageous design of the common-mode/differential-mode choke. As a result of the center limb also being as wide as the outer limbs, the above-mentioned advantageous mutual distance between the induction coils is automatically achieved. Whilst, in comparable chokes, it was hitherto conventional for the center limb to be at least twice as wide as the two outer limbs, the center limb in the present case is designed to be narrower, namely the same width as the outer limbs, resulting in the advantageous adjustment of the inductances.

It is furthermore preferably provided that the three limbs are connected to one another at one end by a first main limb. This results in a core part with an E-shaped design, with an advantageous magnetic flux.

It is further preferably provided that at least the outer limbs are connected to one another at another end by a second main limb, which, in particular, forms an I-shaped core part. A clearance is thus provided between the two main limbs, which serves for receiving the mutually facing active portions of the induction coils. The third limb or the center limb moreover projects into this clearance, which limb extends to the second main limb so that the clearance is divided into two clearances by the center limb. In this case, the core as a whole is designed, in particular, to be EI-shaped as a result of the second main limb.

Alternatively, the core is preferably designed to be UI-shaped, EE-shaped or UU-shaped depending on whether the core has three or only two limbs. Further fields of application are thus realized for the advantageous choke.

According to a preferred embodiment, the center limb ends at a distance from the second main limb so that there is an air gap between the center limb and the second main limb. The size of the air gap therefore determines the value of the inductances. By shortening the center limb, it is therefore possible to adapt the inductances to different applications in a simple manner. In an extreme case, the center limb extends to the second main limb; in another extreme case, the limb length of the center limb is zero, so that the E-shaped core becomes a U-shaped core. The inductances achieve their maximum value if the air gap is bridged completely to the second main limb by the center limb; the size of the air gap is therefore zero. The inductances achieve their minimum value if the air gap between the center limb and the second main limb is at its maximum. In the latter case, the stray inductance depends mainly on the mutual geometric arrangement of the windings.

### BRIEF DESCRIPTION OF THE DRAWINGS

The inventive inverter is notable for the inventive common-mode/differential-mode choke. This results in the above-mentioned advantages. The invention shall be explained in more detail below with the aid of the drawings, which show:

FIG. 1 a circuit diagram of an integrated common-mode/differential-mode choke and

FIGS. 2A and 2B an exemplary embodiment of the common-mode choke.

### DETAILED DESCRIPTION

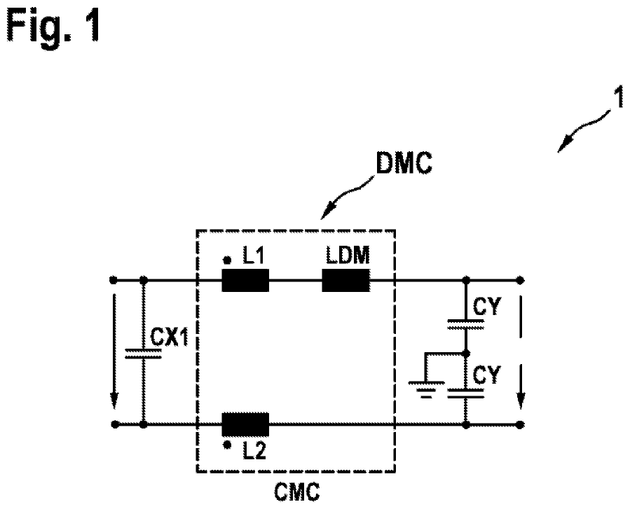

FIG. 1 shows, in a simplified illustration, a circuit diagram of a common-mode/differential-mode choke 1, which is realized in a component. The choke 1 has induction coils L1, L2 and LDM, wherein the induction coils L1 and LDM are connected in parallel to the induction coil L2. A first voltage drops as a result of a capacitor CX1 associated with the high-voltage power supply, and a voltage on the low-voltage side drops as a result of two further capacitors CY, between which there is a ground connection. In this case, the choke is connected, in particular, to a circuit of a transformer (not illustrated here in more detail). The coils L1 and L2 and LDM form a common-mode choke CMC and the coils L1 and LDM form a differential-mode choke DMC.

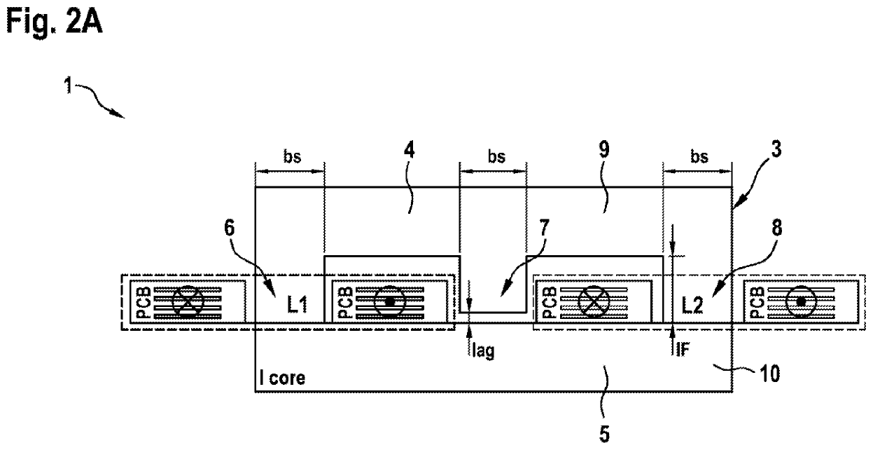

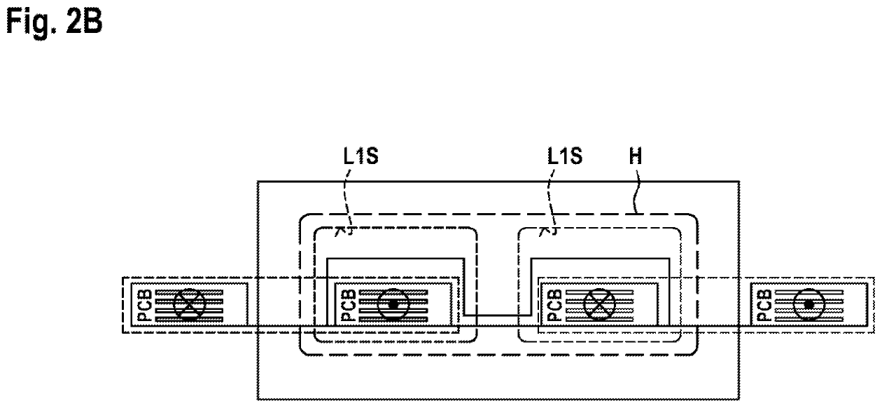

FIGS. 2A and 2B show an exemplary embodiment of the choke 1 in a simplified illustration, wherein FIG. 2A shows the dimensioning and FIG. 2B shows magnetic stray fields of the choke 1.

These show the construction of the choke 1 in a planar technique. This can also be applied to inductors wound with wires. An EI core shape of a core 3 of the choke 1 is shown in the drawing. The core 3 therefore has an E-shaped core part 4 and an I-shaped core part 5. The E-shaped core part 4 has three limbs 6, 7 and 8, which are aligned to be parallel and at a distance from one another and which stem from a main limb 9 so that the E shape is produced. The I-shaped core part 5 lies opposite the E-shaped core part 4, so that the I-shaped core part 5 lies parallel to the main limb 4 and itself forms a second main limb 10, which lies with its end face on the outer limbs 6 and 8 so that there is contact between the limbs 8, 9 and the main limb 10 or the I-shaped core part 5.

The center limb 7 lying between the limbs 6 and 8 has a shortened design, so that an air gap l_{ag} is produced. In this case, the air gap l_{ag} according to the present exemplary embodiment is smaller than the length IF of the outer limbs 6, 8.

The coil L1 is wound around the limb 6 as a differential-mode induction coil and the coil L2 is wound around the limb 8 as a common-mode induction coil. The limbs 6, 7 and 8 each have the same width bs so that the distance between the mutually facing winding portions of the coils L1 and L2 at their mutually facing sides in the E core part 9 is the same size as the internal diameter of the coils at the respective limb 6, 8.

In this case, the fields or magnetic fluxes shown in FIG. 2B are produced during operation. The main flux flows through the windings, so that a main field H is produced. In addition to this, each induction winding L1, L2 has a separate stray field L1S or L2S, which does not flow through the other induction winding in each case. The main field H is generated by the main inductance Lh and the stray fields by the respective stray inductances L_{σ}.

A coupling k between the windings of the induction coils L1 and L2 is adjusted as a result of the specific adjustment of the air gap l_{ag}. The inductances LDM and LCM also change as a result of the change in k. LDM and Lh achieve their maximum value with an air gap of lag=0 mm. Conversely, the inductances LDM and Lh are at their minimum value with an air gap of lag=IF. In this case, the center limb 7 is omitted completely and the previous I core part 4 becomes a U core part or a U-shaped core. The stray inductance in this case depends mainly on the mutual geometric arrangement of the windings or the induction coils L1, L2. Depending on the core geometry and material, the value of Lh changes by circa 20% from the minimum value over the entire change in length of the air gap lag. In contrast to this, the value of the inductance LDM changes by circa 8000% in relation to its minimum value. Considering these very different changes in value of the inductances, it can be assumed that the value of the common-mode choke is relatively constant whilst the value of the differential-mode choke is highly adjustable. With this arrangement, values of LDM of at least pH to >100 μH are achieved. The saturation of the magnetic material must again be taken into account for the dimensioning of the inductor.

The choke 1 can also be realized with two E cores or two U cores or one UI core combination. The windings of the induction coils L1 and L2 are not wound around the center limb 7 of the core as is usual; they are each wound around the outer limbs 6, 8. This increases the stray inductance L_{σ} of the common-mode choke. In this construction, L_{σ}=LDM and the main inductance Lh corresponds to the common-mode inductance LCM, i.e. Lh=LCM.

A further advantage comes to light in the case of high-voltage applications, since both windings or induction coils L1, L2 are not stacked on top of one another but are placed at a spacing beside one another. The insulation requirements can therefore be fulfilled without difficulty. Since the windings are not constructed on top of one another, it is moreover possible to use all copper layers for each winding. This reduces the ohmic resistance of the windings, which minimizes the copper losses of the common-mode choke. Furthermore, a greater degree of freedom in terms of the configuration of the individual windings is achieved by the construction, since they do not have to be stacked on top of one another. Since the three limbs 6, 7 and 8 have the same width bs, highly precise adjustment of the inductances is possible.

1. A common-mode/differential-mode choke (1) for an electrically operable motor vehicle, the choke comprising:
a core (4) having at least two limbs (6, 8) aligned parallel and at a distance from one another,
a common-mode induction coil (L1), and
a differential-mode induction coil (L2), wherein the two induction coils (L1, L2) are each wound around one of the two limbs (6, 8), and wherein the distance between mutually facing winding portions of the two induction coils (L1, L2) corresponds to the mutual distance between the winding portions of at least one of the induction coils (L1, L2) on both sides of the respective limb (6, 8).

2. The choke as claimed in claim 1, wherein the core (4) has a center limb (7), and wherein the center limb (7) is arranged between the two limbs (6, 8) and is aligned at a distance and parallel to these.

3. The choke as claimed in claim 1, wherein the three limbs (6, 7, 8) have the same width (bs).

4. The choke as claimed in claim 1, wherein the three limbs (6, 7, 8) are connected to one another at one end by a first main limb (10).

5. The choke as claimed in claim 1, wherein the core (4) is EI shaped.

6. The choke as claimed in claim 1, wherein the core (4) is UI-shaped, EE-shaped or UU-shaped.

7. The choke as claimed in claim 1, wherein the center limb (7) ends at a distance from the second main limb (10) so that there is an air gap (l_{ag}) between the center limb (7) and the second main limb (10).

8. A transformer with a circuit arrangement which is arranged between a high-voltage side and a low-voltage side, wherein a common-mode/differential-mode choke (1) is arranged or connected on at least one of the sides of the transformer and comprises:
a core (4) having at least two limbs (6, 8) aligned parallel and at a distance from one another,
a common-mode induction coil (L1), and
a differential-mode induction coil (L2), wherein the two induction coils (L1, L2) are each wound around one of the two limbs (6, 8), and wherein the distance between mutually facing winding portions of the two induction coils (L1, L2) corresponds to the mutual distance between the winding portions of at least one of the induction coils (L1, L2) on both sides of the respective limb (6, 8).
